(19) United States
(12) Patent Application Publication
(10) Pub. No.: US 2016/0134523 A1
(43) Pub. Date: May 12, 2016

(54) NETWORK ROUTING SYSTEM AND NETWORK PACKET ROUTING METHOD THEREOF

(71) Applicant: Institute For Information Industry, Taipei (TW)

(72) Inventors: Po-Wen CHI, Taipei City (TW); Jing-Wei GUO, Tainan City (TW)

(21) Appl. No.: 14/556,217

(22) Filed: Nov. 30, 2014

(30) Foreign Application Priority Data
Nov. 12, 2014 (TW) 103139195

(51) Int. Cl. H04L 12/717; H04L 12/751

(52) U.S. Cl. CPC H04L 45/42; H04L 45/02

(57) ABSTRACT

A network routing system and a network packet routing method thereof are provided. The network routing system includes a control server and a network switch. The control server creates a first routing configuration based on topology of the network routing system. The first routing configuration includes a first routing information match field and a first routing setup field. The control server transmits the first routing configuration to the network switch. The network switch receives a first network packet from a first network node, and determines that a piece of first routing information of the first network packet matches the first routing information match field. The network switch creates a second routing configuration according to the first routing setup field. The second routing configuration includes a second routing information match field and a second routing setup field.

### PRIORITY

This application claims priority to Taiwan Patent Application No. 103139195 filed on Nov. 12, 2014, which is hereby incorporated by reference in its entirety.

### FIELD

The present invention relates to a network routing system and a network packet routing method thereof, and more particularly, the network routing system and the network packet routing method thereof according to the present invention mainly utilize a network switch to partake in routing decision for a network packet.

### BACKGROUND

In conventional software-define networks (SDNs), the protocol between the control server and the switch mainly follows the OpenFlow specification. The switch has a related Flow table stored therein, and the Flow table records Flow entries related to the network packet transmission path.

Specifically, upon receiving a network packet, the switch firstly determines whether the network packet matches a condition of any Flow entry specification in the Flow table in according to information of the packet. If the answer is “yes”, then the network packet is transmitted according to the content recorded in the Flow entry; and otherwise, if the answer is “no”, the network packet is transmitted to the control server which then analyzes the content of the network packet and notifies the switch of the routing path of the network packet to facilitate subsequent transmission of the network packet by the switch.

However, in the conventional SDNs described above, contents of the Flow entries recorded by the switch are too complex, so mismatches between the network packet and the Flow entries tend to occur when the switch matches the network packet with the Flow entries and, consequently, the switch and the control server have to exchange network packets and control messages therebetween frequently. Thus, a too large message flow is caused between the switch and the control server to result in an inadequate bandwidth therebetween; and moreover, the control server has to spend more resources in determining the routing path for the network packet, which leads to a degradation in overall usage efficiency of the network.

Accordingly, an urgent need exists in the art to provide a solution capable of reducing unnecessary message transmissions between the switch and the control server so as to reduce the bandwidth consumption therebetween and the computational burden of the control server and to further improve the overall usage efficiency of the SDN.

### SUMMARY

A primary objective of the present invention includes providing a network packet routing method for a network routing system. The network routing system in certain embodiments comprises a network switch and a control server. The network switch connects to the control server. The network packet routing method comprises the following steps of: (a) enabling the control server to create a first routing configuration according to topology of the network routing system, wherein the first routing configuration comprises a first routing information match field and a first routing setup field; (b) enabling the control server to transmit the first routing configuration to the network switch; (c) enabling the network switch to receive a first network packet from a first network node; (d) enabling the network switch to determine that a piece of first routing information of the first network packet matches the first routing information match field; and (e) enabling the network switch to create a second routing configuration according to the first routing setup field after the step (d). The second routing configuration comprises a second routing information match field and a second routing setup field.

To achieve the aforesaid objective, certain embodiments of the present invention include a network routing system, which comprises a control server and a network switch. The control server is configured to: create a first routing configuration which comprises a first routing information match field and a first routing setup field according to topology of the network routing system; and transmit the first routing configuration to the network switch. The network switch is configured to: receive a first network packet from a first network node; determine that a piece of first routing information of the first network packet matches the first routing information match field; and create a second routing configuration which comprises a second routing information match field and a second routing setup field according to the first routing setup field.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a network routing system according to a first embodiment of the present invention;

FIG. 1B is a block diagram of a network switch according to the first embodiment of the present invention;

FIG. 1C is a schematic view of a routing configuration according to the first embodiment of the present invention;

FIG. 2A is a schematic view of the network routing system according to a second embodiment of the present invention;

FIG. 2B is a schematic view of the routing configuration according to the second embodiment of the present invention;

FIG. 3 is a flowchart diagram of a network packet routing method according to a third embodiment of the present invention; and

FIGS. 4A-4B show a flowchart diagram of the network packet routing method according to a fourth embodiment of the present invention.

### DETAILED DESCRIPTION

In the following description, certain embodiments of the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

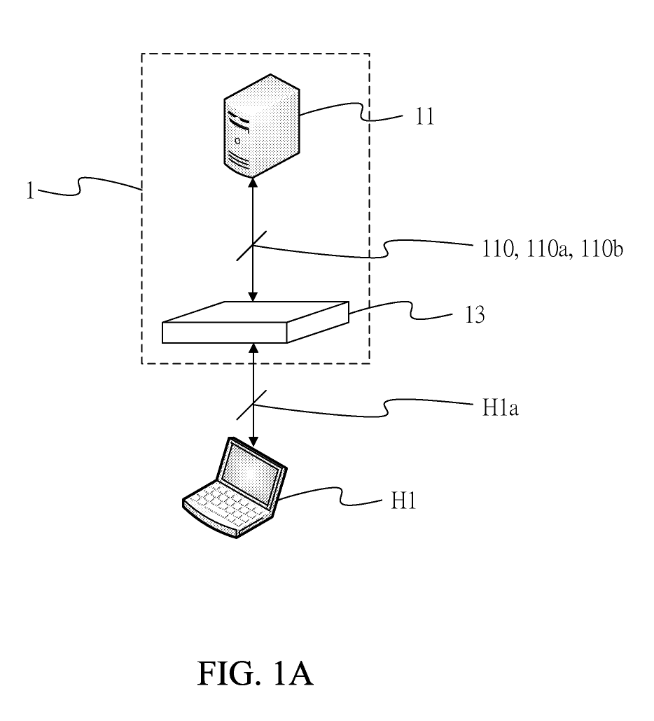

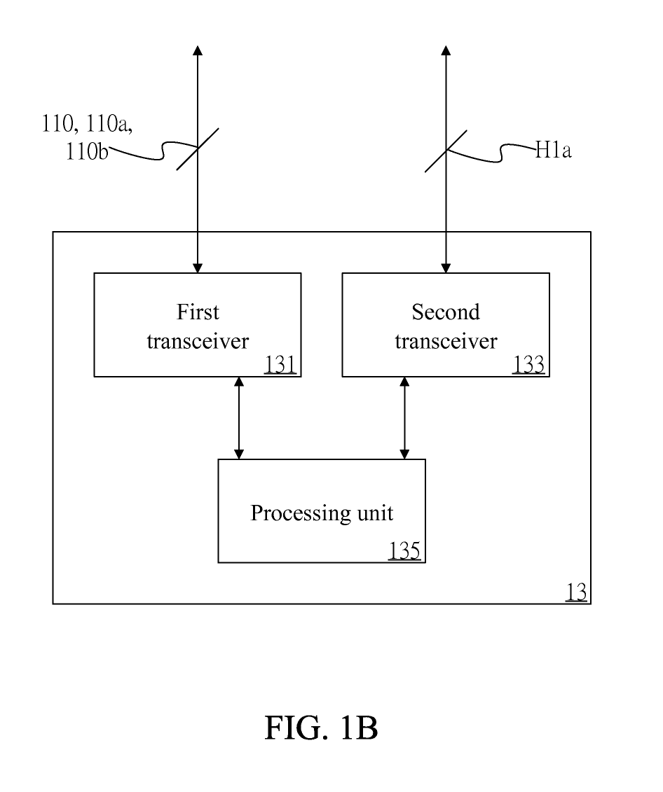

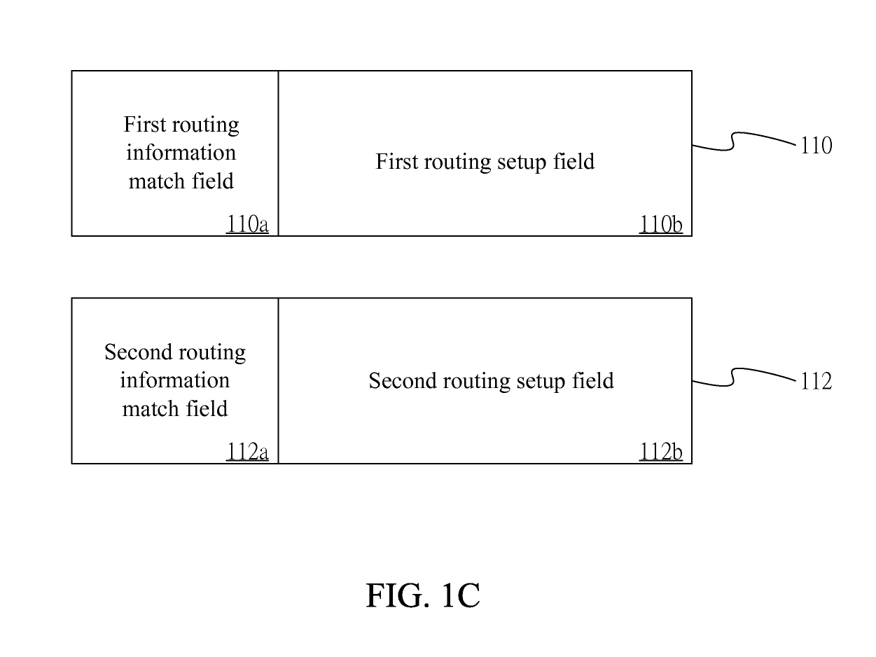

Please refer to FIGS. 1A˜-1B together. FIG. 1A is a schematic view of a network routing system 1 according to a first embodiment of the present invention, and the network routing system 1 comprises a control server 11 and a network switch 13. FIG. 1B is a block diagram of the network switch 13 according to the first embodiment of the present invention, and the network switch 13 comprises a first transceiver 131, a second transceiver 133 and a processing unit 135. The first transceiver 131 and the second transceiver 133 are electrically connected with the processing unit 135 respectively. The first transceiver 131 is connected with the control server 11, and the second transceiver 133 is connected with a first network node H1. The process of packet routing will be further described hereinafter.

Firstly, before the network packet of a node is processed by the network routing system 1, the control server 11 must firstly create a routing rule template in the network switch 13. Please refer to FIG. 1C together, which is a schematic view of a routing configuration according to the first embodiment of the present invention. Specifically, the control server 11 firstly creates a first routing configuration 110 according to topology of the network routing system 1. The first routing configuration 110 comprises a first routing information match field 110a and a first routing setup field 110b.

More specifically, because the control server has a capability of determining topology, the control server 11 in the first embodiment may determine topology of the network routing system 1 and, accordingly, determine that the network routing system 1 and the first network node H1 have a network connection therebetween so as to further decide the first routing information match field 110a and the first routing setup field 110b of the first routing configuration 110. Afterwards, the control server 11 transmits the first routing configuration 110 to the network switch 13 so that the first transceiver 131 of the network switch 13 receives the first routing configuration 110, and then, stores and installs the first routing configuration 110 into the network switch 13.

Next, after the second transceiver 133 of the network switch 13 has received a first network packet H1a from the first network node H1, the processing unit 135 of the network switch 13 firstly makes a comparison between a piece of first routing information (not depicted) of the first network packet H1a and the routing information match field of the routing configuration stored in the network switch 13 one by one. In the first embodiment, the processing unit 135 of the network switch 13 determines that the first routing information of the first network packet H1a matches the first routing information match field 110a of the first routing configuration 110.

Accordingly, the processing unit 135 of the network switch 13 may, in response to the determining result, create a second routing configuration 112 with more specific routing conditions according to the first routing setup field 110b corresponding to the first routing information match field 110a. The second routing configuration 112 comprises a second routing information match field 112a and a second routing setup field 112b so that the network switch 13 routes all network packets matching the second routing information match field 112a according to the rules of the second routing setup field 112b subsequently.

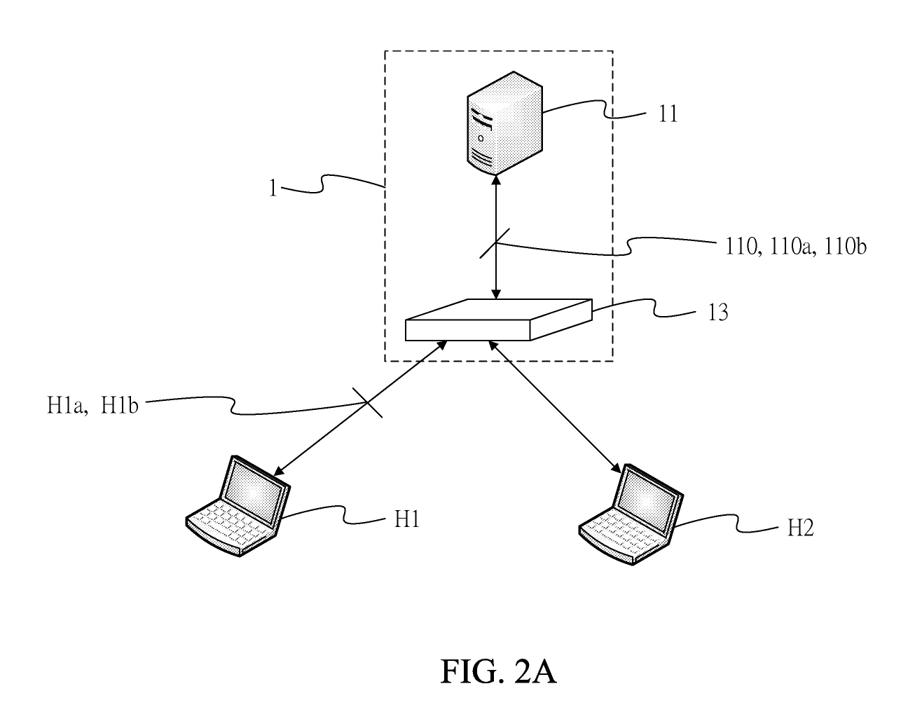

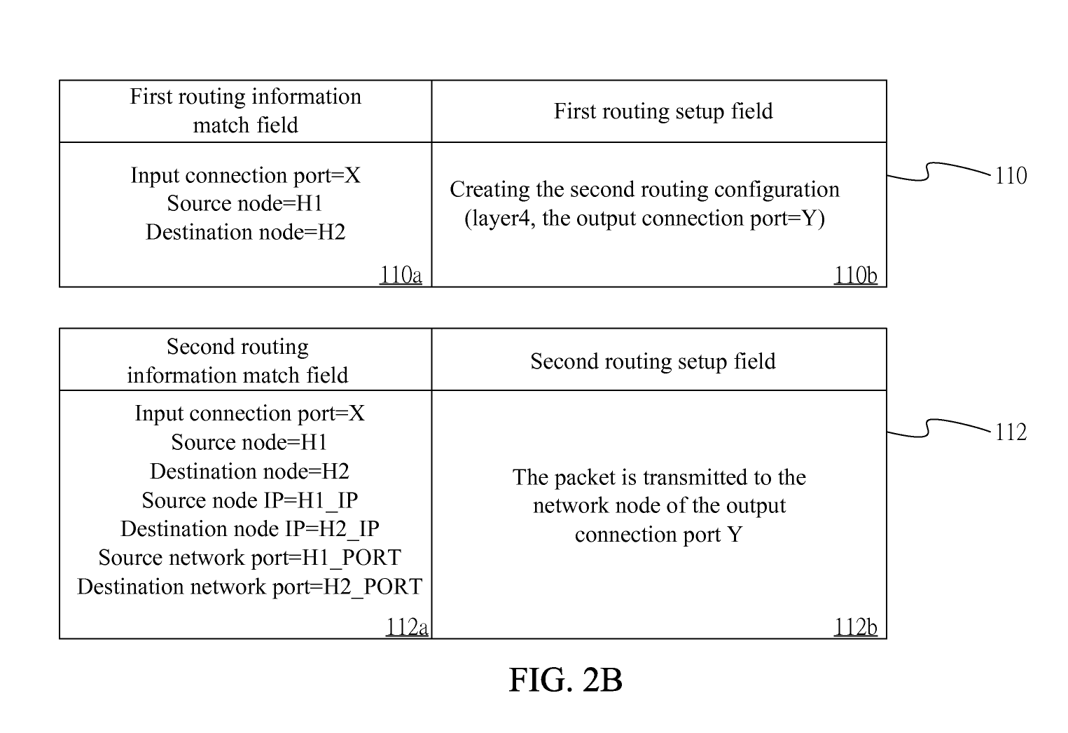

Please refer to FIG. 2A and FIG. 2B. FIG. 2A is a schematic view of the network routing system 1 according to a second embodiment of the present invention, and FIG. 2B is a schematic view of the routing configuration according to the second embodiment of the present invention. It should be particularly appreciated that, the architecture of the second embodiment is the same as that of the previous embodiment, so the components with the same reference numerals also have the same functions and, thus, will not be further described herein. However, in the second embodiment, the network switch 13 further connects with a second network node H2. The second embodiment is mainly intended to illustrate the contents of the routing configuration and usage thereof.

Specifically, in the second embodiment, the contents of the first routing information match field 110a comprise screening conditions where an input connection port is X, a source node is H1 and a destination node is H2, while the contents of the first routing setup field 110b comprise a network layer parameter and a setup rule where an output connection port is Y. The network layer parameter is mainly used to specify which network layer's information needs to be used by the contents of the second routing configuration H2, and the network layer parameter of the second embodiment is layer 4.

Further speaking, after the first network packet H1a is received by the second transceiver 133 of the network switch 13 from the first network node H1, the processing unit 135 of the network switch 13 firstly makes a comparison between the first routing information of the first network packet H1a and the routing information match field of the routing configuration stored in the network switch 13 one by one. In the second embodiment, the first routing information of the first network packet H1a comprises that the input connection port is X, the source node is H1 and the destination node is H2.

Accordingly, the processing unit 135 of the network switch 13 can determine that the first routing information of the first network packet H1a matches the first routing information match field 110a of the first routing configuration 110. Afterwards, the processing unit 135 of the network switch 13 may create a second routing configuration 112 with more specific routing conditions according to the first routing setup field 110b corresponding to the first routing information match field 110a.

Specifically, the processing unit 135 of the network switch 13 creates the second routing configuration 112 with more specific routing conditions mainly according to the network layer parameter and the specification that the output connection port shall be Y. The second routing information match field 112a mainly specifies the match information based on the fourth layer (transport layer) of the network layers in such a way that the second routing information match field 112a comprises screening conditions where the input connection port is X, the source node is 111, the destination node is 112, the source node is IP H1_IP, the source network port is H1_PORT, the destination node is IP H2_IP and the destination network port is H2_PORT. The second routing setup field 112b is set to route the packet to the output connection port Y of the network switch 13.

Next, for the routing of the first network packet H1a, the processing unit 135 of the network switch 13 may make a second comparison between a piece of second routing information of the first network packet H1a and the second routing configuration 112 after the second routing configuration 112 is created. More specifically, the second routing information of the first network packet H1a is contents of the first routing information extended in the fourth layer of the network layers, and comprises that the source node is 111, the connection port between the source node 111 and the network switch 13 is X, the destination node is 112, the source node is IP H1_IP, the source network port is H1_PORT, the destination node is IP H2_IP and the destination network port is H2_PORT.

Accordingly, the processing unit 135 of the network switch 13 can determine that the second routing information of the first network packet H1a matches the second routing information match field 112a of the second routing configuration 112. Then, the processing unit 135 of the network switch 13 transmits the first network packet H1a to the second network node H2 connected with the connection port Y of the network switch 13 directly according to the second routing setup field 112b corresponding to the second routing information match field 112a so as to accomplish the routing of the first network packet H1a

Next, similarly, after a second network packet H1b is received by the second transceiver 133 of the network switch 13 from the first network node H1 subsequently, the processing unit 135 of the network switch 13 makes a comparison between a piece of third routing information of the second network packet H1b and the second routing configuration 112. Likewise, the third routing information of the second network packet H1b comprises that the source node is H1, the connection port between the source node H1 and the network switch 13 is X, the destination node is H2, the source node IP is H1_IP, the source network port is H1_PORT, the destination node is IP H2_IP and the destination network port is H2_PORT.

Accordingly, the processing unit 135 of the network switch 13 determines that the third routing information of the second network packet H1b matches the second routing information match field 112a of the second routing configuration 112. Afterwards, the processing unit 135 of the network switch 13 transmits the second network packet H1b to the second network node H2 connected with the connection port Y of the network switch 13 directly according to the second routing setup field 112b corresponding to the second routing information match field 112a so as to accomplish the routing of the second network packet H1b.

Additionally, the first transceiver 131 of the network switch 13 may further transmits the second routing configuration 112 to the control server 11 so that the control server 11 can record the second routing configuration 112 and, accordingly, determine whether the contents of the second routing configuration 112 need modification. If the control server 11 determines that the contents of the second routing configuration 112 need a modification, the control server 11 may transmit a control message to the network switch 13 to notify the network switch 13 to make a corresponding modification.

It should be particularly emphasized that, the contents of the second embodiment are provided to only illustrate possible implementations of the present invention rather than to limit the contents of the routing configuration and conditions thereof, and people skilled in the art may readily devise the possible information applications and replacements according to the contents of the specification.

For example, the second network node H2 may also be a wide area network (WAN) gateway with a network address translation (NAT) function. In this case, the second routing setup field 112b may be further set in such a way that a corresponding NAT transformation is performed on the packet firstly, and then route the packet to the wide area network via the output connection port Y of the network switch 13, thus ensuring that the network packet can be transmitted to the destination correctly.

Additionally, likewise, the network routing system of the present invention conforms to the specification of the SDN network system, and is developed based on the SDN network system. However, this is not intended to limit the network environment in which the present invention is implemented.

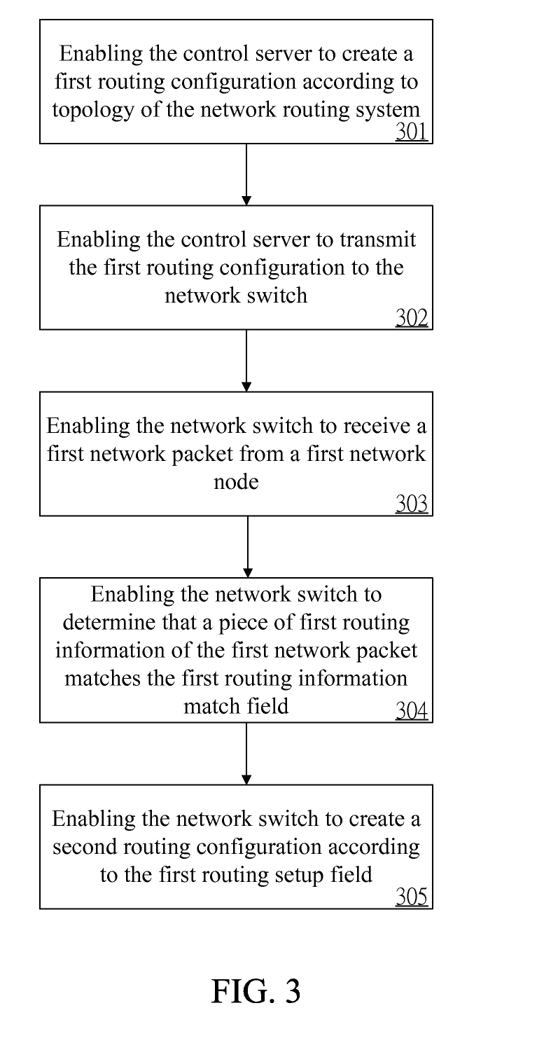

A third embodiment of the present invention is a network packet routing method, a flowchart diagram of which is shown in FIG. 3. The method of the third embodiment is for use in a network routing system (e.g., the network routing system 1 of the previous embodiments). The network routing system comprises a network switch and a control server, and the network switch is connected to the control server. The detailed steps of the third embodiment are described as follows.

Firstly, a step 301 is executed to enable the control server to create a first routing configuration according to topology of the network routing system. The first routing configuration comprises a first routing information match field and a first routing setup field. A step 302 is executed to enable the control server to transmit the first routing configuration to the network switch. Then, a step 303 is executed to enable the network switch to receive a first network packet from a first network node.

Next, a step 304 is executed to enable the network switch to determine that a piece of first routing information of the first network packet matches the first routing information match field. Finally, a step 305 is executed to enable the network switch to create a second routing configuration according to the first routing setup field for subsequent routing of the network packet. The second routing configuration comprises a second routing information match field and a second routing setup field.

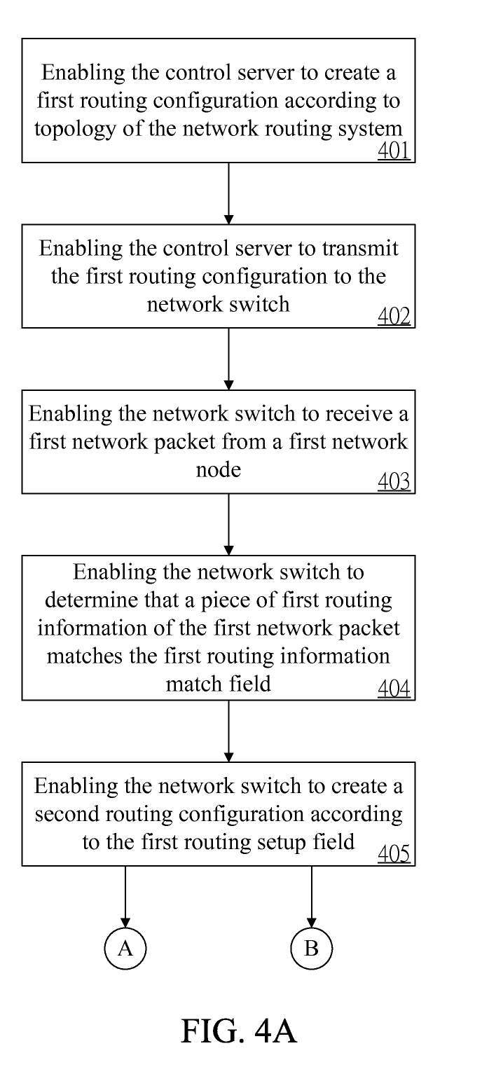

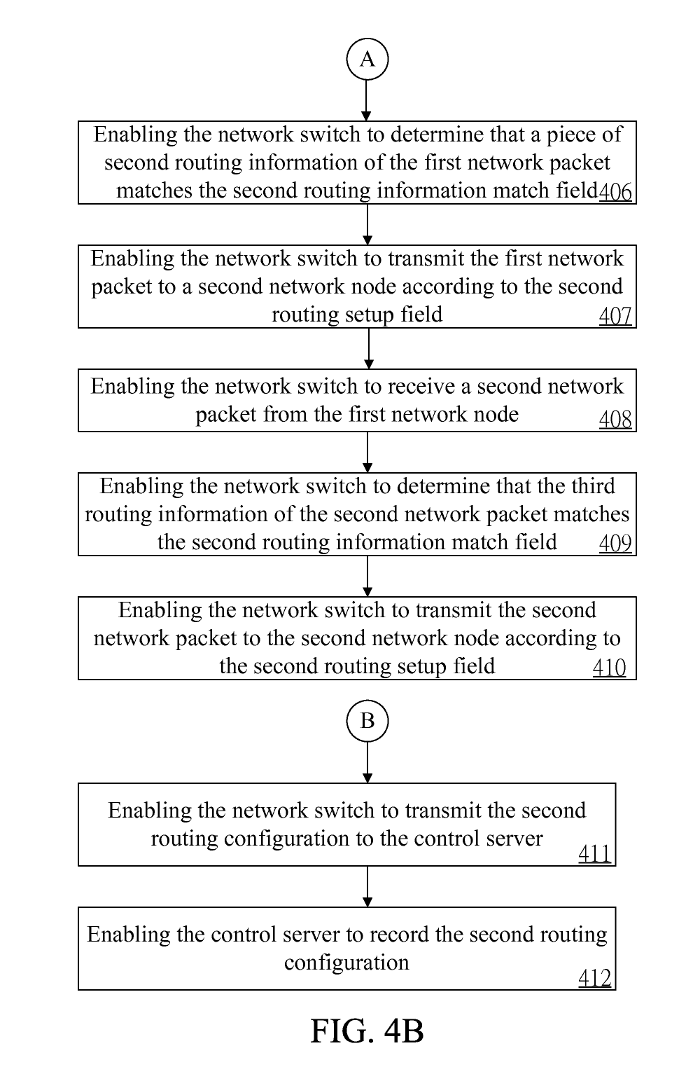

A fourth embodiment of the present invention is a network packet routing method, a flowchart diagram of which is shown in FIGS. 4A-4B. The method of the fourth embodiment is for use in a network routing system (e.g., the network routing system 1 of the previous embodiments). The network routing system comprises a network switch and a control server, and the network switch is connected with the control server. The detailed steps of the fourth embodiment are described as follows.

Firstly, a step 401 is executed to enable the control server to create a first routing configuration according to topology of the network routing system. The first routing configuration comprises a first routing information match field and a first routing setup field. A step 402 is executed to enable the control server to transmit the first routing configuration to the network switch. Afterwards, a step 403 is executed to enable the network switch to receive a first network packet from a first network node.

Next, a step 404 is executed to enable the network switch to determine that a piece of first routing information of the first network packet matches the first routing information match field. A step 405 is executed to enable the network switch to create a second routing configuration according to the first routing setup field for subsequent routing of the network packet. The second routing configuration comprises a second routing information match field and a second routing setup field.

Afterwards, a step 406 is executed to enable the network switch to determine that a piece of second routing information of the first network packet matches the second routing information match field. The second routing information comprises the first routing information. A step 407 is executed to enable the network switch to transmit the first network packet to a second network node according to the second routing setup field.

Next, similarly, a step 408 is executed to enable the network switch to receive a second network packet from the first network node. A step 409 is executed to enable the network switch to determine that a piece of third routing information of the second network packet matches the second routing information match field. Finally, a step 410 is executed to enable the network switch to transmit the second network packet to the second network node according to the second routing setup field.

It should be particularly appreciated that, a step 411 and a step 412 may be executed optionally. In detail, optionally after the step 405, the step 411 may be executed to enable the network switch to transmit the second routing configuration to the control server, and the step 412 is executed to enable the control server to record the second routing configuration so that the control server subsequently determines whether to make an adjustment on the second routing configuration.

According to the above descriptions, after a network packet of any network node is received, the network routing system and the network packet routing method thereof of the present invention may create an advanced routing configuration (e.g., the second routing configuration) according to the primary-level routing configuration template (e.g., the first routing configuration) that covers routing conditions of a wider scope, and route the related network packet according to the advanced routing configuration directly by the network switch. Thereby, occurrences that the network packet mismatches with the regulations due to the too complicated routing specification and, thus, still needs to be transmitted to the control server are greatly reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network packet routing method for a network routing system, the network routing system comprising a network switch and a control server, and the network switch connecting to the control server, the network packet routing method comprising:
(a) the control server creating a first routing configuration according to topology of the network routing system, wherein the first routing configuration comprises a first routing information match field and a first routing setup field;
(b) the control server transmitting the first routing configuration to the network switch;
(c) the network switch receiving a first network packet from a first network node;
(d) the network switch determining that a piece of first routing information of the first network packet matches the first routing information match field; and
(e) the network switch creating a second routing configuration according to the first routing setup field after the step (d), wherein the second routing configuration comprises a second routing information match field and a second routing setup field.

2. The network packet routing method of claim 1, further comprising:
(f) the network switch determining that a piece of second routing information of the first network packet matches the second routing information match field, wherein the second routing information comprises the first routing information; and
(g) the network switch transmitting the first network packet to a second network node according to the second routing setup field after the step (f).

3. The network packet routing method of claim 2, further comprising:
(h) the network switch receiving a second network packet from the first network node;
(i) the network switch determining that a piece of third routing information of the second network packet matches the second routing information match field; and
(j) the network switch transmitting the second network packet to the second network node according to the second routing setup field after the step (i).

4. The network packet routing method of claim 1, further comprising:
(f) the network switch transmitting the second routing configuration to the control server; and
(g) the control server recoding the second routing configuration.

5. A network routing system, comprising:
a control server; and
a network switch;
wherein the control server is configured to:
create a first routing configuration according to topology of the network routing system, wherein the first routing configuration comprises a first routing information match field and a first routing setup field;
transmit the first routing configuration to the network switch;
wherein the network switch is configured to:
receive a first network packet from a first network node;
determine that a piece of first routing information of the first network packet matches the first routing information match field; and
create a second routing configuration according to the first routing setup field, wherein the second routing configuration comprises a second routing information match field and a second routing setup field.

6. The network routing system of claim 5, wherein the network switch is further configured to:
determine that a piece of second routing information of the first network packet matches the second routing information match field, wherein the second routing information comprises the first routing information; and
transmit the first network packet to a second network node according to the second routing setup field.

7. The network routing system of claim 6, wherein the network switch is further configured to:
receive a second network packet from the first network node;
determine that a piece of third routing information of the second network packet matches the second routing information match field; and
transmit the second network packet to the second network node according to the second routing setup field.

8. The network routing system of claim 5, wherein the network switch is further configured to transmit the second routing configuration to the control server, and the control server is further configured to record the second routing configuration.

9. A network packet routing method for a network switch, the network switch connecting to a control server, the network packet routing method comprising:
(a) the network switch receiving a first routing configuration from the control server, wherein the first routing configuration comprises a first routing information match field and a first routing setup field;
(b) the network switch receiving a first network packet from a first network node;
(c) the network switch determining that a piece of first routing information of the first network packet matches the first routing information match field; and
(d) the network switch creating a second routing configuration according to the first routing setup field after the step (c), wherein the second routing configuration comprises a second routing information match field and a second routing setup field.

10. The network packet routing method of claim 9, further comprising:
(e) the network switch determining that a piece of second routing information of the first network packet matches the second routing information match field, wherein the second routing information comprises the first routing information; and
(f) the network switch transmitting the first network packet to a second network node according to the second routing setup field after the step (e).

11. The network packet routing method of claim 10, further comprising:
(g) the network switch receiving a second network packet from the first network node;
(h) the network switch determining that a piece of third routing information of the second network packet matches the second routing information match field; and
(i) the network switch transmitting the second network packet to the second network node according to the second routing setup field after the step (h).

12. The network packet routing method of claim 9, further comprising:
(e) the network switch transmitting the second routing configuration to the control server so that the control server records the second routing configuration.

13. A network switch for a network routing system, the network routing system further comprising a control server connected to the network switch, the network switch comprising:
a first transceiver, being configured to receive a first routing configuration from the control server, wherein the first routing configuration comprises a first routing information match field and a first routing setup field;
a second transceiver, being configured to receive a first network packet from a first network node;
a processing unit, being configured to:
determine that a piece of first routing information of the first network packet matches the first routing information match field; and
create a second routing configuration according to the first routing setup field, wherein the second routing configuration comprises a second routing information match field and a second routing setup field.

14. The network switch of claim 13, wherein the processing unit is further configured to:
determine that a piece of second routing information of the first network packet matches the second routing information match field, wherein the second routing information comprises the first routing information; and
transmit the first network packet to a second network node via the second transceiver according to the second routing setup field.

15. The network switch of claim 14, wherein the second transceiver is further configured to:
receive a second network packet from the first network node;
wherein the processing unit is further configured to:
determine that a piece of third routing information of the second network packet matches the second routing information match field; and
transmit the second network packet to the second network node via the second transceiver according to the second routing setup field.

16. The network switch of claim 13, wherein the second transceiver is further configured to:
transmit the second routing configuration to the control server so that the control server records the second routing configuration.
